(19) United States
(12) Patent Application Publication
(10) Pub. No.: US 2024/0219749 A1
(43) Pub. Date: Jul. 4, 2024

(54) ANTI DEEP FAKE HEADGEAR

(71) Applicant: Alexander D. Haussmann, Lakewood, CO (US)

(72) Inventor: Alexander D. Haussmann, Lakewood, CO (US)

(21) Appl. No.: 18/140,162

(22) Filed: Apr. 27, 2023

Related U.S. Application Data
(60) Provisional application No. 63/436,556, filed on Dec. 31, 2022.

(51) Int. Cl. G02C 5/00; G02B 3/08; G02C 5/02

(52) U.S. Cl. CPC G02C 5/001; G02B 3/08; G02C 5/02

(57) ABSTRACT

Anti deep fake headgear distorts the path of light rays passing from a wearer's face. The distortion effect is random due to the headgear having optical distortion devices which dangle freely in front of the wearer's face and may both swing in two dimensions and rotate in a third dimension or may themselves bend. A circlet or bridge with temples and temple tips is worn about the crown of the head or around the face from ear to ear, with an extension from the front carrying one or more suspension members in turn carrying one or more optical distortion devices. The suspension members may be limber members and the optical distortion devices may be lenses, Fresnel lenses, strips of transparent or translucent and flexible materials, Fresnel lenses, material simply having a refractive index different than air, etc.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but reserves all copyright rights whatsoever. 37 CFR 1.71(d).

### CROSS-REFERENCE TO RELATED APPLICATIONS

N/A

### FIELD OF THE INVENTION

This invention relates generally to security devices and specifically to devices for preventing easy deepfaking of human faces.

### STATEMENT REGARDING FEDERALLY FUNDED RESEARCH

This invention was not made under contract with an agency of the US Government, nor by any agency of the US Government.

### BACKGROUND OF THE INVENTION

Deep fake technology expands the ability to create artificial video of person's saying or doing things that they did not in fact say or do. This technology is an outgrowth of the overall rapid advancement of AI programming, however, the societal implications are becoming more obvious and quite alarming.

Deepfake videos of famous actors have been created which seemingly depict the actors in movies in which they did not actually appear. Deepfake videos have also been used to generate false pornography videos. Deepfake videos have been used to create false political messages and to slander notable figures by seemingly showing them saying or doing things which they did not do.

While deepfake technology has been used for some benign purposes with consent of those depicted, in general it is necessary to find some way to limit the scope for deep fake creation.

Thus it is becoming necessary to provide a device which prevents deepfake technology from being employed on a given individual's depiction at a certain time or place.

It would also be advantageous to provide a method to reduce the ease of deepfaking, or prevent it altogether, by increasing the processing power required to create a deepfake, hopefully to the point that it becomes impossible.

These and other advantages, aspects, and objectives of the present invention will be disclosed herein.

### SUMMARY OF THE INVENTION

### General Summary

The present invention teaches headgear which a person wears on their head and which distorts the path of light rays passing from the person's face to viewers in front of the individual. The distortion effect is random due to the headgear having optical distortion devices which dangle freely in front of the wearer's face and may both swing in two dimensions and rotate in a third dimension, or even themselves change shape.

Thus the device may take the form of a circlet worn about the crown of the head, with an extension from the front carrying one or more suspension members in turn carrying one or more optical distortion devices. The suspension members may be rigid but in the best mode presently contemplated and current preferred embodiment the suspenders are limber members such as ribbon, string, flexible wire, polymers, rubbers and the like. The optical distortion devices may be lenses, Fresnel lenses, strips of transparent or translucent and flexible materials, strips of transparent Fresnel lenses of flexible material, strips of material simply having a refractive index different than that of ambient air (thus causing refraction of light rays) and strips of material which reflect different colors when viewed at different angles. Since these lenses or strips may be free to rotate and swing and also to bend in different shapes under the influence of the wearer's breath and motions, the angles of view and portions of the face covered may change from moment to moment.

In other embodiments the device may have a bridge across the forehead or bridge of the nose of a wearer, temples extending backward therefrom on both sides of the head, temple tips securing the device by extending behind the ears, and then the extender may project from a medial portion of the bridge. The extender may have a cross-piece thereon so that two or more optical distorters may be dangled in parallel to the wearer's facial plane rather than sequentially as in the embodiment discussed in the previous paragraph.

### Summary in Reference to Claims

It is therefore another objective, advantage, aspect and embodiment of the invention (in addition to those previously discussed) to provide anti deep fake headgear comprising:
a bridge of resilient material having left and right ends, first and second temples respectively connected to the left and right ends of the bridge;
first and second temple tips respectively connected to the first and second temples;
at least one extender having first and second ends, the first end of the at least one extender connected to the bridge;
a cross-piece having first and second ends, the first end of the cross-piece connected to the second end of the extender;
at least one optical distorter dangling below the cross-piece and free to move in relation to the cross-piece.

It is therefore another objective, advantage, aspect and embodiment of the invention to provide anti deep fake headgear wherein the extender is connected to a medial portion of the bridge.

It is therefore another objective, advantage, aspect and embodiment of the invention to provide anti deep fake headgear wherein the at least one optical distorter is suspended from the cross-piece.

It is therefore another objective, advantage, aspect and embodiment of the invention to provide anti deep fake headgear wherein the at least one optical distorter is suspended from at least one suspender, the at least one suspender comprising a limber member, the suspender in turn suspended from the cross-piece.

It is therefore another objective, advantage, aspect and embodiment of the invention to provide anti deep fake headgear wherein the at least one optical distorter further comprises a lens. It is therefore another objective, advantage, aspect and embodiment of the invention to provide anti deep fake headgear wherein the at least one optical distorter lens further comprises a Fresnel lens.

It is therefore another aspect, objective, advantage and embodiment of the invention to provide anti deep fake headgear wherein the at least one optical distorter further comprises a strip of transparent material having a refractive index different than a refractive index of air.

It is therefore another aspect, objective, advantage and embodiment of the invention to provide anti deep fake headgear wherein the at least one optical distorter further comprises a strip of translucent material having the optical property of displaying different colors when viewed from different angles.

It is therefore another aspect, objective, advantage and embodiment of the invention to provide an anti deep fake device, for use worn on a head, the anti deep fake device comprising:
a circlet dimensioned and configured to sit atop such head;
an extender connected to a medial portion of the circlet;
a first suspender connected to the extender;
a first optical distorter dangling from the first suspender.

It is therefore another aspect, objective, advantage and embodiment of the invention to provide an anti deep fake device, wherein the suspender further comprises a limber member.

It is therefore another aspect, objective and embodiment of the invention, in addition to those discussed previously, to provide an anti deep fake device, wherein the suspender further comprises a rigid member.

It is therefore another aspect, objective and embodiment of the invention, in addition to those discussed previously, to provide an anti deep fake device, further comprising:
a second suspender comprising a limber member;
a second optical distorter dangling from the second suspender;

It is therefore another aspect, objective and embodiment of the invention, in addition to those discussed previously, to provide an anti deep fake device, wherein the second suspender is disposed distal to the circlet, with the first suspender disposed at a medial portion of the extender, wherein the first and second optical distorters dangle at different distances from such head.

It is therefore another aspect, advantage, objective and embodiment of the invention, in addition to those discussed previously, to provide an anti deep fake device, wherein the first and second optical distorters further comprise lenses.

It is therefore another aspect, advantage, objective and embodiment of the invention, in addition to those discussed previously, to provide an anti deep fake device, wherein the first and second optical distorters further comprise Fresnel lenses.

It is therefore another aspect, advantage, objective and embodiment of the invention, in addition to those discussed previously, to provide an anti deep fake device, wherein the first and second optical distorters further comprise strips of transparent material having refractive indices different than a refractive index of air.

It is therefore another aspect, advantage, objective and embodiment of the invention, in addition to those discussed previously, to provide an anti deep fake device, wherein the first and second optical distorters further comprise strips of translucent material having the optical property of displaying different colors when viewed from different angles.

### BRIEF DESCRIPTION OF THE DRAWINGS

FIG. 1 is an orthogonal left front view diagram of a first embodiment of the invention showing various parts thereof.

FIG. 2 is an orthogonal left front view diagram of a second embodiment of the invention showing various parts thereof.

FIG. 3 is a side view diagram of the second embodiment of the invention showing fewer parts thereof but displaying the profile.

FIG. 4 is an orthogonal left elevational front view diagram of a third embodiment of the invention showing various parts thereof in a circlet embodiment.

FIG. 5 is an orthogonal left elevational front view diagram of a fourth embodiment of the invention showing various parts thereof in a circlet embodiment.

FIG. 6 is an orthogonal left front view diagram of a fifth embodiment of the invention showing various parts thereof.

FIG. 7 is an orthogonal left elevational front view diagram of a sixth embodiment of the invention showing various parts thereof in another circlet embodiment.

FIG. 8 is a front view of a human being exaggerating the effect on human features of a distortion device such as a lense as might be used in the sixth embodiment (FIG. 8 does not display an embodiment) of the invention, and “freezing” the distortion at a single moment in time (the present invention has constantly moving distortion devices due to wearer breathing, normally undetectable head motions, walking, etc).

### INDEX TO REFERENCE NUMERALS

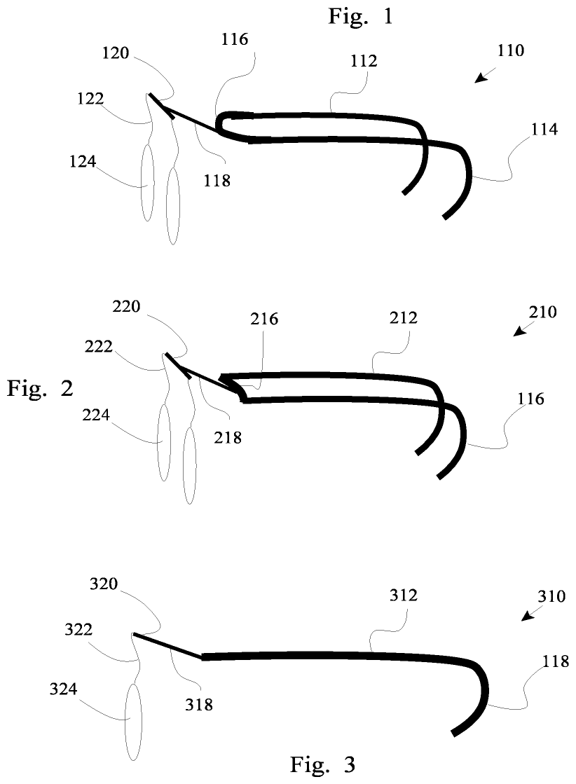

FIG. 1
Anti deepfake headgear 110
Temple 112
Temple tip 114
Bridge 116
Extender 118
Cross-piece 120
Suspender 122
Lenses 124

FIG. 2
Anti deepfake headgear 210
Temple 212
Temple tip 214
Bridge 216
Extender 218
Cross-piece 220
Suspender 222
Lenses 224

FIG. 3
Anti deepfake headgear 310
Temple 312
Temple tip 314
Extender 318
Suspender 322
Lenses 324

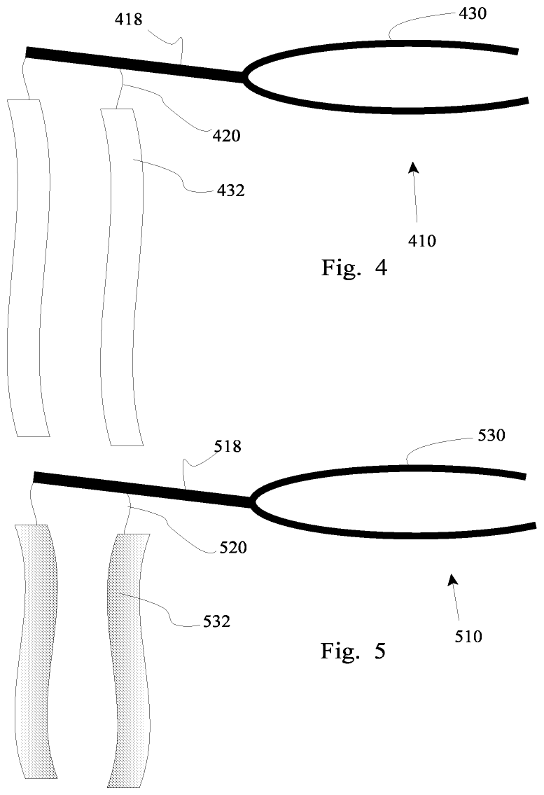

FIG. 4
Anti deepfake headgear 410
Extender 418
Suspender 420
Circlet 430
Streamer 432

FIG. 5
Anti deepfake headgear 510
Extender 518
Suspender 520
Circlet 530
Streamer (sequential) 532
Fresnel lense 534

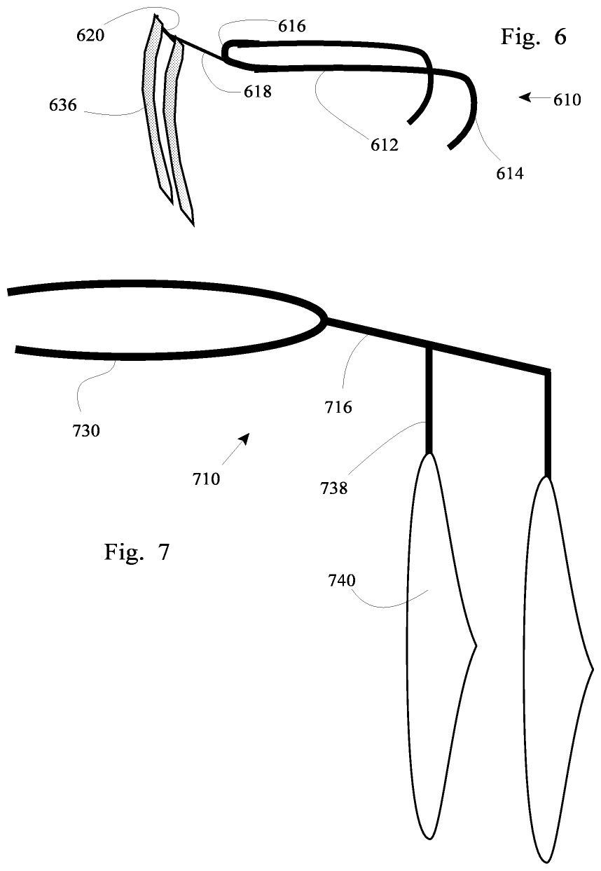

FIG. 6
Anti deepfake headgear 610
Temple 612
Temple tip 614
Bridge 616
Extender 618
Cross-piece 620
Streamer (perpendicular) 636

FIG. 7
Anti deepfake headgear 710
Extender 716
Circlet 730
Rigid suspender 738
Lense 740

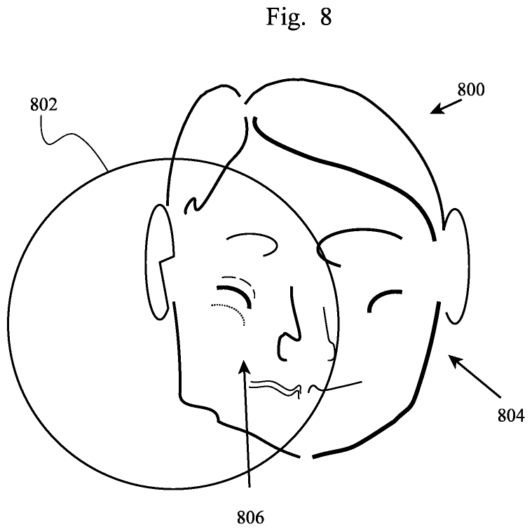

FIG. 8
Wearer 800
Lense 802
Face 804
Distorted face (exaggerated distortion) 806

### DETAILED DESCRIPTION

### Glossary

For purposes of this application, the term optical distorters refers to any device which may refract light rays passing therethrough. The optical distortion devices may be lenses, Fresnel lenses, strips of transparent or translucent and flexible materials, strips of transparent Fresnel lenses of flexible material, strips of material simply having a refractive index different than that of ambient air (thus causing refraction of light rays) and strips of material which reflect different colors when viewed at different angles.

The term limber member may refer to ribbon, string, flexible wire, polymer strands, rubber members and so forth, and may be considered to be the antonym of “rigid” as used herein.

The term “dangling” refers to a high degree of freedom of motion relative to the face of a wearer of the invention and relative to the portions of the invention such as circlets or bridges/temples/temple tips which are firmly secured to the user's head. This high degree of relative motion may include swinging in two dimensions, rotating, also vertical motion due to stretching of the optical distorter or the suspending limber member, and flexing of the optical distorter itself so that it's own distortion effect is altering from moment to moment. The aspect of random alterations of the optical distortion across the time domain is important to the invention.

A circlet is a thin member which passes about the crown of the head, circlets are often seen in tiaras and the like.

Bridge, temple and temple tips all have the normal meanings.

For purposes of this application the term ‘connected to’ means ‘affixed to’.

### End Glossary

FIG. 1 is an orthogonal left front view diagram of a first embodiment of the invention showing various parts thereof. Anti deepfake headgear 110 has two temples 112 terminating in temple tips 114. A wearer will put the temple tips behind their ears and bridge 116 across their forehead. Extender 118 may project from a medial portion of the bridge 116, or it may project from either end of bridge 116. Cross-piece 120 at the end of the extender 118 will allow the separation of two optical distorters apart from one another. Suspending member 122 may advantageously be limber (flexible, see Glossary) to allow numerous degrees of freedom of motion of the lenses 124 as they dangle before the user's face.

Note that lenses 124 are positioned dangling loosely in front of a user's eyes and thus may give the false impression of being for vision enhancement of the user. This is the exact opposite of the fundamental principle of operation of the invention: the dangling and randomly moving lenses are distort the vision of viewers of the user, not improve the vision of the user. They cannot even be used for vision enhancement since they do have numerous degrees of freedom of motion (three to seven degrees of freedom of motion depending upon the exact sub-embodiment and limber member used).

FIG. 2 is an orthogonal left front view diagram of a second embodiment of the invention showing various parts thereof. Anti deepfake headgear 210 has temples 212 and temple tips 214 but in this case bridge 216 passes across the bridge of the nose of the wearer rather than across the forehead. Extender 218 carries cross-piece 220 connected thereto, and in turn supporting suspenders 222 which finally allow lenses 224 to dangle freely, as in the previous embodiment.

FIG. 3 is a side view diagram of the second embodiment of the invention showing fewer parts thereof but displaying the profile. Anti deepfake headgear 310 has clearly visible one temple 312 and one temple tip 314 as well as extender 318 which carries the visible suspender 322 and finally the visible lens 324.

Lenses 324 are depicted to be convex but may be concave, irregular, or even flat but having other optical distortion properties such as being polarized, irregularly colored and so forth.

FIG. 4 is an orthogonal left elevational front view diagram of a third embodiment of the invention showing various parts thereof in a circlet embodiment. Anti deepfake headgear 410 is worn upon the head rather like a tiara by placing circlet 430 about the crown of the head.

Extender 418 may project from the center of the circlet 430 but need not be so confined in space: it may be movable, may project from one side or one end of the circlet 430 and so forth.

Suspender 420 is once again a limber member but in this embodiment it suspends a streamer 432 which serves as the optical distorter. Note that flexible streamers 432 have the advantage over rigid lenses of being able to change its own shape randomly, thus providing even further alterations in the light ray path distortions and thus vastly increasing the processing power necessary to try to mimic the subject's face.

Note that simply by having a different index of refraction from ambient air, the streamers will cause ray path disturbances.

FIG. 5 is an orthogonal left elevational front view diagram of a fourth embodiment of the invention showing various parts thereof in a circlet embodiment. Anti deepfake headgear 510 once again has extender 518 projecting from the circlet 530, with extender 518 supporting one or more suspenders 520 which in turn carry one or more streamers 532 in a sequential alignment from medial the user's face and the end of the extender 518 up to the distal end of the extender 518.

Sequential arrangement has an advantage in that central portions of the user's face will now be distorted twice as viewed using light rays passing through the two streamers. This squaring of the distortion results in possibly insoluble computational burdens for AI deepfake systems.

In this embodiment, the streamers are in fact the type of flat grooved lenses known as Fresnel lenses 534. These will introduce yet another layer of distortion.

FIG. 6 is an orthogonal left front view diagram of a fifth embodiment of the invention showing various parts thereof. Anti deepfake headgear 610 has temple 612 which runs beside the temple of a wearer's head, temple tip 614 which lodges behind the ears, bridge 616 crossing the forehead (not the bridge of the nose), extender 618 and cross-piece 620. In this embodiment there is no suspender “622” instead, the streamers 636 depend directly from the cross-piece 620, which may have spikes, posts, clips or other devices thereon (shown but rather small) to directly support the streamers 636.

FIG. 7 is an orthogonal left elevational front view diagram of a sixth embodiment of the invention showing various parts thereof in another circlet embodiment. In this embodiment the anti deepfake headgear 710 has extender 716 from circlet 730 with a rigid suspender 738 for a much larger lens/lenses 740.

FIG. 8 is a front view of a human being exaggerating the effect on human features of a distortion device such as a lense as might be used in the sixth embodiment (FIG. 8 does not display an embodiment) of the invention, and “freezing” the distortion at a single moment in time (the present invention has constantly moving distortion devices due to wearer breathing, normally undetectable head motions, walking, etc). Wearer 800 has some sort of lens or distortion device 802 in front of part of their face 804, causing certain distorted facial features 806.

The invention is NOT intended to make the wearer look like some kind of Hollywood special effect monster: FIG. 8 deliberately exaggerates the distortion for clarity.

In addition, this distortion is of course shown in a single diagram at a single moment. In the invention, it is the preferred embodiment and current best mode contemplated to allow the optical distorter to fluctuate in shape and location and orientation so that the distortion is continually changing across time. As discussed previously, this continual alteration of the distortion will dramatically increase the processing power and depth of AI learning needed to attempt to model and then present an undistorted deep fake.

The disclosure is provided to render practicable the invention by those skilled in the art without undue experimentation, including the best mode presently contemplated and the presently preferred embodiment. Nothing in this disclosure is to be taken to limit the scope of the invention, which is susceptible to numerous alterations, equivalents and substitutions without departing from the scope and spirit of the invention. The scope of the invention is to be understood from the appended claims.

Methods and components are described herein. However, methods and components similar or equivalent to those described herein can be also used to obtain variations of the present invention. The materials, articles, components, methods, and examples are illustrative only and not intended to be limiting.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art.

Having illustrated and described the principles of the invention in exemplary embodiments, it should be apparent to those skilled in the art that the described examples are illustrative embodiments and can be modified in arrangement and detail without departing from such principles. Techniques from any of the examples can be incorporated into one or more of any of the other examples. It is intended that the specification and examples be considered as exemplary only, with a true scope and spirit of the invention being indicated by the following claims.

What is claimed is:

1. Anti deep fake headgear comprising:
a bridge of resilient material having left and right ends,
first and second temples respectively connected to the left and right ends of the bridge;
first and second temple tips respectively connected to the first and second temples;
at least one extender having first and second ends, the first end of the at least one extender connected to the bridge;
a cross-piece having first and second ends, the first end of the cross-piece connected to the second end of the extender;
at least one optical distorter dangling below the cross-piece and free to move in relation to the cross-piece.

2. The anti deep fake headgear of claim 1, wherein the extender is connected to a medial portion of the bridge.

3. The anti deep fake headgear of claim 2, wherein the at least one optical distorter is suspended from the cross-piece.

4. The anti deep fake headgear of claim 2, wherein the at least one optical distorter is suspended from at least one suspender, the at least one suspender comprising a limber member, the suspender in turn suspended from the cross-piece.

5. The anti deep fake headgear of claim 4, wherein the at least one optical distorter further comprises a lens.

6. The anti deep fake headgear of claim 5, wherein the at least one optical distorter lens further comprises a Fresnel lens.

7. The anti deep fake headgear of claim 4, wherein the at least one optical distorter further comprises a strip of transparent material having a refractive index different than a refractive index of air.

8. The anti deep fake headgear of claim of claim 4, wherein the at least one optical distorter further comprises a strip of translucent material having the optical property of displaying different colors when viewed from different angles.

9. An anti deep fake device for use worn on a head, the anti deep fake device comprising:
a circlet dimensioned and configured to sit atop such head;
an extender connected to a medial portion of the circlet;
a first suspender connected to the extender;
a first optical distorter dangling from the first suspender.

10. The anti deep fake device of claim 9, wherein the suspender further comprises a limber member.

11. The anti deep fake device of claim 9, wherein the suspender further comprises a rigid member.

12. The anti deep fake device of claim 10, further comprising:
a second suspender comprising a limber member;
a second optical distorter dangling from the second suspender;

13. The anti deep fake device of claim 12, wherein the second suspender is disposed distal to the circlet, with the first suspender disposed at a medial portion of the extender, wherein the first and second optical distorters dangle at different distances from such head.

14. The anti deep fake device of claim 13, wherein the first and second optical distorters further comprise lenses.

15. The anti deep fake device of claim 14, wherein the first and second optical distorters further comprise Fresnel lenses.

16. The anti deep fake device of claim 13, wherein the first and second optical distorters further comprise strips of transparent material having refractive indices different than a refractive index of air.

17. The anti deep fake device of claim 13, wherein the first and second optical distorters further comprise strips of translucent material having the optical property of displaying different colors when viewed from different angles.
